(19) United States
(12) Patent Application Publication
(10) Pub. No.: US 2015/0201016 A1
(43) Pub. Date: Jul. 16, 2015

(54) METHODS AND SYSTEM FOR INCORPORATING A DIRECT ATTACHED STORAGE TO A NETWORK ATTACHED STORAGE

(71) Applicants: Amit GOLANDER, Tel-Aviv (IL); David FLYNN, Sandy, UT (US); Ben Zion HALEVY, Tel-Aviv (IL)

(72) Inventors: Amit GOLANDER, Tel-Aviv (IL); David FLYNN, Sandy, UT (US); Ben Zion HALEVY, Tel-Aviv (IL)

(21) Appl. No.: 14/154,220

(22) Filed: Jan. 14, 2014

(51) Int. Cl. H04L 29/08

(52) U.S. Cl. CPC H04L 67/1097

(57) ABSTRACT

A Computerized storage system management methods and system configurations. In some embodiments the invention comprises a computer storage data access structure, a DS management and a storage system solution related to methods and a system geared for implementing a scale-out NAS that can effectively utilize client side Flashes while the Flash utilization solution is based on pNFS, the pNFS is comprised of a meta-data server (MDS) and data servers (DSs). There are at least one client and two Data servers, wherein at least one of them is a Direct Attached (Tier0), client level DS. Tier0 DS is a client-side resident low latency memory selected from a group of solid state memories, defined as Storage Class Memories, such as a Flash memory, serving as an integral lowest level of a storage system with a shared storage hierarchy of levels (Tier 0, 1, 2 and so on) and the unified name space.

### FIELD AND BACKGROUND OF THE INVENTION

The present invention, in some embodiments thereof, relates to computer storage data access advanced configurations and memory content management solutions; and more particularly, but not exclusively, to methods and system for implementing a scale-out NAS that can effectively utilize client side solid state memory Flashes, or in general Storage Class Memories (SCM), while the SCM utilization solution is based on pNFS that is comprised of a meta-data server (MDS) and data servers (DSs).

High-performance data centers have been aggressively moving toward parallel technologies like clustered computing and multi-core processors. While this increased use of parallelism overcomes the vast majority of computational bottlenecks, it shifts the performance bottlenecks to the storage I/O system. To ensure that compute clusters deliver the maximum performance, storage systems must be optimized for parallelism. The industry standard Network Attached Storage (NAS) architecture has serious performance bottlenecks and management challenges when implemented in conjunction with large scale, high performance compute clusters. Parallel storage takes a very different approach by allowing compute clients to read and write directly to the storage, entirely eliminating filer head bottlenecks and allowing single file system capacity and performance to scale linearly to extreme levels by using proprietary protocols.

During the recent years, the storage input and/or output (I/O) bandwidth requirements of clients have been rapidly outstripping the ability of Network File Servers to supply them. This problem is being encountered in installations running according to Network File System (NFS) protocol. Traditional NFS architecture consists of a filer head placed in front of disk drives and exporting a file system via NFS. Under a typical NFS architecture, when a client attempts to access a file the situation is becoming complicated when a large number of clients want to access the data simultaneously, or if the data set grows too large. The NFS server then quickly becomes the bottleneck and significantly impacts the system performance since the NFS server sits in the data path between the client computer and the physical storage devices.

In order to overcome this problem, parallel NFS (pNFS) protocol and related system storage management architecture has been developed. pNFS protocol and its supporting architecture allow clients to access storage devices directly and in parallel. The pNFS architecture increases scalability and performance compared to former NFS architectures. This increment is achieved by the separation of data and metadata and using a metadata server out of the data path.

In use, a pNFS client initiates data control requests on the metadata server, and subsequently and simultaneously invokes multiple data access requests on the cluster of data servers. Unlike in a conventional NFS environment, in which the data control requests and the data access requests are handled by a single NFS storage server, the pNFS configuration supports as many data servers as necessary to serve client requests. Thus, the pNFS configuration can be used to greatly enhance the scalability of a conventional NFS storage system. The protocol specifications for the pNFS can be found at URL: www.itef.org, see NFS4.1 standards, at the URL: www.open-pNFS.org and the www.itef.org Requests for Comments (RFC) 5661-5664 which include features retained from the base protocol and protocol extensions. (RFC) 5661-5664 which includes major extensions such as; sessions, directory delegations, external data representation standard (XDR) description, a specification of a block based layout type definition to be used with the NFSv4.1 protocol, and an object based layout type definition to be used with the NFSv4.1 protocol.

Shared storage provides reliability, manageability, advanced data services and cost efficiency for over two decades now. Client-side modern large storage capacity solid state memories such as the fast data access NAND-Flash memory modules, offer large data storage capacity and are becoming highly popular. However, they provide orders of magnitude better performance when servicing applications from the local host, when compared to Flash-based data servers that are accessed over the data center network. Today therefore customers have fast Flash memory storage capacity on their hosts (e.g. Fusion-io ioDrive2), but these are not part of their shared storage infrastructure. It is advised that the client-side Flash would be an integral tier of the shared computer system storage large scale storage.

Client-side Flash memory modules are used today under various configurations and uses, as follows:

a. A Standard Local Storage, wherein their drawbacks are they are not part of the shared storage, so it leads to reduced reliability, data services and cost efficiency.
b. A Scalable Local storage, that scales as part of the application itself (e.g. Facebook) wherein their drawbacks are that they require rewriting the application when up-scaled.
c. A Local storage that has indirection from a shared NAS, so it is under the same namespace. This can be achieved for example by using NFS v4.1 referrals, wherein their drawbacks are that their single namespace eases manageability for users alone and not for the storage administrators, who still have to solve the reliability, data services and cost efficiency of such a distributed system.
d. A Cache Memory for shared storage, such as via NFS v4.1 delegations, wherein their drawback is that a write cache is unreliable. In addition, caches are not cost-efficient when they comprise a large fraction of the storage capacity.
e. An integral portion of an all client-side scale-out storage solution, such as the emerging EMC scale-io technology and VMware virtual SAN, wherein their drawback is that they mathematically disperse the data between block and tend to be block based. In addition these solutions do not tend to integrate well with shared storage, because that is their preliminary objective, to eliminate shared storage.

There is therefore a need in the art for the cases of pNFS type storage systems to enable the client-side Flash and Storage Class Memories (SCM) in general, to be an integral usable and active part of the shared modern computer system storage hierarchy (Tier 1, 2 and so on) and the unified name space.

### GLOSSARY

Network File System (NFS)—a distributed file system open standard protocol that allows a user on a client computer to access files over a network, in a manner similar to how local storage is accessed by a user on a client computer.
NFSv4—NFS version 4 includes performance improvements and stronger security. It supports clustered server deployments, including the ability to provide scalable parallel access to files distributed among multiple servers (the pNFS extension).
Parallel NFS (pNFS)—a part of the NFS v4.1 allows compute clients to access storage devices directly and in parallel. pNFS architecture eliminates the scalability and performance issues associated with NFS servers by the separation of data and metadata and moving the metadata server out of the data path.
pNFS Meta Data Server (MDS)—is a special server that initiates and manages data control and access requests to a cluster of data servers under the pNFS protocol.
Network File Server—a computer appliance attached to a network that has the primary purpose of providing a location for shared disk access, i.e. shared storage of computer files that can be accessed by the workstations that are attached to the same computer network. A file server is not intended to perform computational tasks, and does not run programs on behalf of its clients. It is designed primarily to enable the storage and retrieval of data while the computation is carried out by the workstations.
External Data Representation (XDR)—a standard data serialization format, for uses such as computer network protocols. It allows data to be transferred between different kinds of computer systems. Converting from the local representation to XDR is called encoding. Converting from XDR to the local representation is called decoding. XDR is implemented as a software library of functions which is portable between different operating systems and is also independent of the transport layer.
Storage Area Network (SAN)—a dedicated network that provides access to consolidated, block level computer data storage. SANs are primarily used to make storage devices, such as disk arrays, accessible to servers so that the devices appear like locally attached devices to the operating system. A SAN typically has its own network of storage devices that are generally not accessible through the local area network by other devices. A SAN does not provide file abstraction, only block-level operations. File systems built on top of SANs that provide file-level access, are known as SAN file systems or shared disk file systems.
Network-attached storage (NAS), (also called Filer)—a file-level computer data storage connected to a computer network providing data access to a heterogeneous group of clients. NAS operates as a file server, specialized for this task either by its hardware, software, or configuration of those elements. NAS is often supplied as a computer appliance, a specialized computer for storing and serving files. NAS is a convenient method of sharing files among multiple computers. Its benefits for network-attached storage, compared to file servers, include faster data access, easier administration, and simple configuration.
NAS systems—networked appliances which contain one or more hard drives, often arranged into logical, redundant storage containers or RAIDs. Network-attached storage removes the responsibility of file serving from other servers on the network. They typically provide access to files using network file sharing protocols such as NFS, SMB/CIFS, or AFP.
Redundant Array of Independent Disks (RAID)—a storage technology that combines multiple disk drive components into a logical unit. Data is distributed across the drives in one of several ways called “RAID levels”, depending on the level of redundancy and performance required. RAID is used as an umbrella term for computer data storage schemes that can divide and replicate data among multiple physical drives. RAID is an example of storage virtualization and the array can be accessed by the operating system as one single drive.
Client—A term given to the multiple user computers or terminals on the network. The Client logs into the network on the server and is given permissions to use resources on the network. Client computers are normally slower and require permissions on the network, which separates them from server computers.
Layout—a storage pointer or a Map assigned to an application or to a client containing the location of the specific data package in the storage system memory.
Client's Direct Attached storage (Tier0)—a client-side resident low latency memory device such as Flash memory, serving as an integral lowest level memory tier (Tier0) of a shared system storage hierarchy levels (Tier 1, 2 and so on) and the unified name space.
Flash Memory is an electronic solid state non-volatile computer storage medium that can be electrically erased and reprogrammed. In addition to being non-volatile, Flash memory offers fast read access times. Due to the particular characteristics of flash memory, it is best used in Flash file systems, which spread writes over the media and deal with the long erase times of NOR flash blocks. The basic concept behind flash file systems is the following: when the flash store is to be updated, the file system will write a new copy of the changed data to a fresh block, remap the file pointers, then erase the old block later when it has time.
PCM—Phase Change Memory, (PRAM) a state of the art new solid state non-volatile random access memory type, providing fast access and compact data storage physical packaging needs, PCMs exploit the unique behavior of chalcogenide glass and similar glass like materials. In one generation of the PCMs, heat produced by the passage of an electric current through a heating element would be used to either quickly heat, or quench the glass, making it amorphous, or to hold it in its crystallization temperature range for some time, thereby switching it to a crystalline state. The PCM memory therefore might be used a Direct Attached (tier0) client memory.
SCM—Storage Class Memory, a generic name for emerging new modern generations of advanced performance low latency solid state memories, such as Flash Memory and Phase Change Memory (PCM).
RAIN—Reliable Array of Independent Nodes, also called channel bonding, or redundant array of independent nodes, is a cluster of nodes connected in a network topology with multiple interfaces and redundant storage. RAIN is used to increase fault tolerance. It is an implementation of RAID across nodes instead of across disks.
ASAT—Average Storage Access Time, the present invention defined formula based parameter, for calculating a target optimization function regarding the optimal use in the storage system of local Direct Attached DSs.

### SUMMARY OF THE INVENTION

The following embodiments and aspects thereof are described and illustrated in conjunction with methods and systems, which are meant to be exemplary and illustrative, not limiting in scope. In various embodiments, one or more of the above-described problems have been reduced or eliminated, while other embodiments are directed to other advantageous or improvements.

There is thus a widely-recognized need in the art to scale-out NAS that can effectively utilize at the client side modern Storage Class Memory (SCM) such as Flashes in a storage configuration and management method that is based on pNFS. pNFS is comprised of a meta-data server (MDS) and data servers (DSs).

In the present invention system configuration embodiment there are at least two DSs and at least one of them is a Direct Attached (Tier0) DS: The present invention basic storage system preferred embodiment configuration is based on that at the Client-side Flashes are exported as pNFS DS and optionally pooled together with other Direct Attached DSs.

Optionally, in another embodiment of the present invention the pNFS client layout driver is modified to propose an optimized bypass for local traffic. IO access from a client to the Tier0 DS that resides on the same operating system uses the local file system for the flex-files layout as the transport protocol, whereas it uses a NFS client to access other data servers. Performance measurements indicate that usage of the NFS stack, may delay access to the local Flash by a factor of three

Optionally, in another embodiment of the present invention a similar variation exists for the block layout FIG. 3 is an example of the software stack.

Optionally, in another embodiment of the present invention the MDs placement policy for new files is modified to prefer the Tier0 data server on the creating client, providing that such a local DS exists and has spare capacity. This is performed in order to reduce the Local DS miss rate in the ASAT formula.

Optionally, in another embodiment of the present invention, the Tier0 DSs (in-band) and/or the MDS (out-of-band) counts or assess the access per file. If the MDS decides that node X client is a significant user of a file in the last time period, it could decide to migrate the file to a Tier0 DS that is located on node X.

Optionally, in another embodiment of the present invention the MDS can leverage hints, such as from a VCenter plug-in, to speculate and migrate a file to a node closer to the application using it. One example of such a use case would be VM migration or failover to its passive node.

Shared storage usually includes some level of inter-node redundancy, such as Reliability Across Independent Nodes (RAIN). For clarity, one embodiment of the present invention will use mirroring for inter-node redundancy, thus having two shared copies means that client reads could be accelerated by spreading the load.

In another possible preferred embodiment of the present invention method, access is always faster from/to the local data server, providing that that is an option for the particular file. The secondary copy could be then kept in another Tier0 data server, or on the shared storage (e.g. Tier1).

In another possible preferred embodiment of the present invention storage system organization, the storage organizational structure and hierarchy can be configured to include an option for a random Tier0 data server (best for rebuild).

Yet in another possible preferred embodiment of the present invention memory configuration method, the memory is configured by defining a particular secondary Tier0 DS for a specific file, which is best if a higher level framework (e.g. VMware Fault Tolerant (FT)) or application (e.g. database) has a designated secondary node to be used for failover.

In another preferred embodiment of the present invention the default selection and the usage of Direct Attached storage (Tier0) and of Tier1 for secondary copies in the Storage system is performed automatically, implemented by an algorithm which is an integral part of the present invention method embodiment, wherein the algorithm evaluates three parameters: the network topology, DS capacities & DS performance utilization levels, then weighting all three together in a dedicated algorithm in order to best decide on the default selected DS option per each time interval.

The decision function inputs options are:

1. Static—Usage of Tier0 is discouraged if the network topology does not provide good client to client communication. An opposite example would be Cisco UCS, which provides better throughput and latency between B blades than to external Tier1 storage.
2. Static & Dynamic—Do not allocate secondary on DSs with little free space (capacity). If this applies to all the Tier0 DSs—choose a different and perhaps deeper tier. The shared storage is usually less sensitive to this, as it is easier to administer and cheaper to expand.
3. Dynamic—The same, just based on DS performance utilization. The main difference compared to option 2, is that in option 3 the shared storage is more likely to become the bottleneck.

The present invention second storage copy selection algorithm can be implemented in the MDS, but responsibility for replication itself is an in-band function and thus performed in the client node (either in pNFS client or Tier0 DS software).

In another embodiment of the present invention for the second target storage selection method, required for the creation of the second mirror storage copy, the decision function is a mathematical function with two possible selection options outputs: either the Tier0, or the shared storage (Tier1 in most cases) will be selected as the target for the secondary copy.

The implemented option selection function itself, checks if the multiplication of the 0-1 range three grades values, following the processing of the three grades, is higher than threshold (e.g. 0.5), and then it sets Tier0 to be the default if it is. The networking grade is 0.9 for Tier0, if the client to client communication is faster than the external pipe and 0.1 otherwise. The capacity grade is twice the average free space percentage in Tier0 (the grade tops at 1 if surpasses it). The performance grade is 1—the average spare performance bandwidth the shared storage has. It is to be understood that there are many different possible approaches and variations to be implemented in these equations.

There is thus a widely-recognized need in the art regarding the invention method for configuration and management of storage resources, to scale-out a NAS that can effectively utilize a client Direct Attached fast access, advanced solid state Storage Class Memory modules, such as Flashes, to improve the performance of a storage configuration and management method that is based on pNFS, wherein; a) the pNFS is comprised of a meta-data server (MDS) and data servers (DSs) and a client; b) the NAS contains at least two DSs and at least one of them is a Direct Attached DS that co-resides with said client; and c) wherein said configuration is based on said client-side SCM being further exported as a data server.

In another embodiment of the computerized storage invention method; a) a pNFS client is modified to support the creation of an optimized bypass for local traffic; b) IO access from a client to the Direct Attached DS that resides on the same operating system, is configured to use a local file system or a local block partition instead of a network based transport protocol; and c) the pNFS client uses network to access other data servers.

Yet, in another embodiment of the computerized storage invention method; a) IO access from a client to the Direct Attached DS that resides on the same operating system, is configured to use the local file system for the flex-files layout as the transport protocol; and b) the pNFS client layout driver uses a NFS client to access other data servers.

Furthermore, in another embodiment of the computerized storage invention method; a) IO access from a client to the Direct Attached DS that resides on the same operating system, is configured to use a local block partition for the block layout as the transport protocol; and b) the pNFS client layout driver uses a SCSI initiator to access other data servers.

Yet, in another embodiment of the computerized invention method the MDS placement policy for new files so as to save network traversals is modified to prefer the Direct Attached data server on the creating client, subject it has a sufficient storage capacity for it.

Furthermore, in another embodiment of the computerized storage invention method; a) an in-band Direct Attached Data server counts or assesses the access per file; b) if the Direct Attached Data server decides that node X client is the significant user of a file in the last time period, it could decide to migrate the file to another Direct Attached data server that is located on said node X; and c) said file migration is dependent on node X existence and availability of spare capacity.

Furthermore, in another embodiment of the computerized storage invention method; a) an out-of-band MDS counts or assesses the access per file; b) if the MDS decides that node X client is a significant user of a file in the last time period, it could decide to migrate the file to a Direct Attached data server that is located on said node X; and c) said file migration is dependent on node X existence and availability of spare capacity.

In another embodiment of the computerized invention method the MDS can leverage information from a higher level framework, such as from a vCenter plug-in, to speculate and migrate a file to a node closer to the application using it.

In another embodiment of the computerized storage invention method a shared storage improved data access to a Direct Attached data server located on node X is achieved by files mirroring to provide at least one of the group of benefits, comprising: a) providing a level of inter-node redundancy; and b) accelerating client reads by sharing the load, so that not all clients have to address said node X.

Yet, in another embodiment of the computerized storage invention method, the access is faster from/to a Direct Attached data server, providing that that is an option for a particular file while the secondary copy of said file could be kept in another data server selected from the group comprising of; a Direct Attached data server, and a shared storage DS.

In another embodiment of the computerized storage invention method, a Direct Attached data server maybe a randomly selected best for rebuild Direct Attached DS or a defined particular secondary Direct Attached DS for a specific file, which is best if a higher level framework or application has a designated secondary node alternative, for failover scenarios.

In another embodiment of the computerized storage invention method the default usage of Direct Attached DS and Tier1 DS for secondary copies is performed automatically by an algorithm that evaluates the network topology, DS capacities and performance utilization levels in order to decide on the optimal DS tier selected choice per time interval.

Yet, another embodiment of the computerized storage invention method, a storage DS usage selection algorithm is comprising; a) the usage of a Direct Attached DS is discouraged if the network topology does not provide good client to client communication; b) not to allocate secondary on DSs with little free space (capacity); and c) if this applies to all the available Direct Attached DSs then choose a Tier1 DS, which is usually less sensitive to said limited capacity being easier to administer.

Yet, another embodiment of the computerized storage invention DS usage selection algorithm is; a) the usage of a Direct Attached DS is discouraged if the network topology does not provide good client to client communication; b) not to allocate secondary on an over utilized DS, which cannot support the required performance; and c) if this applies to all the available shared storage DSs then to choose a Direct Attached DS storage as the shared storage is more likely to become the bottleneck.

There is thus a widely-recognized need in the art in having the invention computerized storage system, with a storage configuration and management capabilities of enhanced storage resources, so as to scale-out a NAS that can effectively utilize client Direct Attached fast access, Storage Class Memory based modules, such as Flashes, in a storage systems that is operating under a storage configuration and management method based on pNFS, the NAS in the storage system contains at least two DSs and at least one of them is a Direct Attached DS that co-resides with one of said at least one clients; and wherein the storage configuration is based on the client-side SCM being further exported as a data server.

Yet, in another embodiment of the invention computerized storage system concerning the DS usage selection; a) said pNFS client is modified to support the creation of an optimized bypass for local traffic; b) IO access from a client to the Direct Attached DS that resides on the same operating system, is configured to use a local file system or a local block partition instead of a network based transport protocol; and c) said pNFS client uses network to access other data servers.

Furthermore, in another embodiment of the invention computerized storage system, the IO access from a client to the Direct Attached DS that resides on the same operating system, is configured to use the local file system for the flex-files layout as the transport protocol; and b) the pNFS client layout driver uses a NFS client to access other data servers.

Furthermore, in another embodiment of the invention computerized storage system; a) an in-band Direct Attached Data server counts or assesses the access per file; b) if said Direct Attached Data server decides that node X client is the significant user of a file in the last time period, it could decide to migrate the file to another Direct Attached data server that is located on said node X; and c) the file migration is dependent on a node X existence and availability of spare capacity.

Furthermore, in another embodiment of the invention computerized storage system a shared storage improved data access to a Direct Attached data server located on node X is achieved by files mirroring to provide at least one of the group of benefits, comprising: a) providing a level of inter-node redundancy, and b) accelerating client reads by sharing the load, so that not all clients have to address the node X.

Unless otherwise defined, all technical and/or scientific terms used herein have the same meaning as commonly understood by one of ordinary skill in the art to which the invention pertains. Although methods and systems similar or equivalent to those described herein can be used in the practice or testing of embodiments of the invention, exemplary methods and/or systems are described below. In case of conflict, the patent specification, including definitions, will control. In addition, the materials, methods, systems and examples herein are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a schematic illustration of the present invention system storage configuration, while implementing and integrating into the shared storage configuration also the shared Direct Attached (Tier0) storage level SCM or Flash based system clients' local memories.

FIG. 2A is an example of the full path an NFS client (not pNFS though) has to traverse even if the DS is on the same node. According to some embodiment of the invention instead the pNFS layout driver can create a shortcut and approach the VFS and through that the local file system.

FIG. 2B is an example of the full path and a shortcut that can be done for other pNFS layout types. According to some embodiment of the invention instead the pNFS layout driver can create a shortcut wherein the bypass path would be pNFS layout driver leading to a SCSI layer.

FIGS. 3A and 3B are schematic flow chart illustrations of a state machine wherein states reflect actions and transition arrows relate to internal or external triggers, which are performed with regard to a certain files content in the system data server mirroring algorithm used according to one embodiment of the present invention.

FIG. 4.A. is a schematic illustration of the present invention computerized system storage content and configuration, while implementing mirroring of files and wherein client A is mirroring and storing one or more files stored in its Direct Attached DS also in client B direct attached DS.

FIG. 4.B. is a schematic illustration of the present invention computerized system storage content management configuration, while implementing mirroring of files and wherein client A is mirroring and storing one or more files stored in its Direct Attached DS also in the system NAS shared storage (Tier1).

FIG. 4.C. is a schematic illustration of the present invention computerized system storage content management and configuration, while implementing mirroring of files and wherein the Direct Attached DS of client A is mirroring and storing one or more files stored in its memory also in client B Direct Attached DS memory.

FIG. 4.D is a schematic illustration of the present invention computerized system storage content management and configuration, while implementing mirroring of files and wherein the Direct Attached DS of client A is mirroring and storing one or more files stored in it, also in the system NAS shared storage (Tier1).

FIGS. 5A and 5B are schematic flow chart illustrations of a state machine wherein states reflect actions and transition arrows relate to internal or external triggers, which are performed in the storage system MDS with regard to a certain files content concerning secondary mirrored file copies on Tier0 or Tier1 DS in the system data server mirroring algorithm used according to one embodiment of the present invention.

### DETAILED DESCRIPTION OF EMBODIMENTS OF THE INVENTION

The present invention, in some embodiments thereof, relates to advanced storage configuration and management solutions and, more particularly, but not exclusively, to methods and system of a computer storage data access advanced configuration and a memory contents management advanced storage system solution; and more particularly, but not exclusively, to methods and a storage system for implementing a scale-out NAS so it can effectively utilize client side Flashes or SCM in general while the SCM utilization solution is based on pNFS.

Before explaining at least one embodiment of the invention in details, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash/SSD memory), an optical fiber, a portable compact disc read-only memory (CD-ROM), an optical storage device, a magnetic storage device, a RAID, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to electronic, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

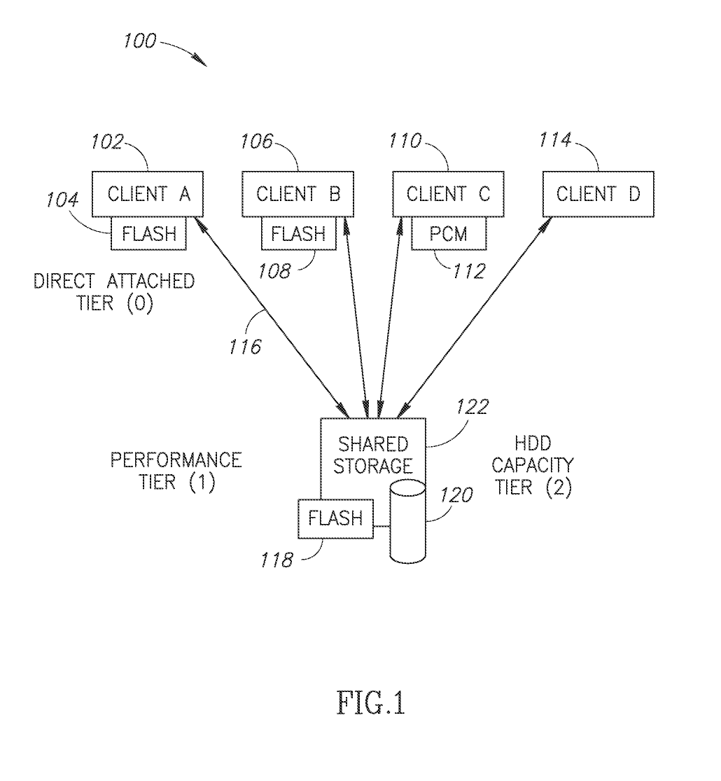

Reference is now made to FIG. 1, which is an illustration of reference demonstrating a schematic illustration of a storage system 100 according to one embodiment of the present invention. FIG. 1 is a schematic illustration of the present invention system storage configuration, while implementing and integrating into a pNFS shared storage configuration also the shared Direct Attached (Tier0) client's storage level DS using for it SCM type DSs, such as a Flash DS and a PCM DS as the clients' local memories. Client A. 102, is part of the storage system 100 that the storage system 100 is using its integrated local flash memory 104 also as its direct attached (tier0) shared memory storage DS, according one important embodiment of the present invention. Client B. 106 is another similar client that the storage system 100 is using its integrated local flash memory 108 also as a Direct Attached DS, that Flash memory 108 is serving, thus implementing one embodiment of the present invention sharing and serving other system 100 clients storage needs, while managed under a pNFS based, MDS system manager. Client C. 110 is another client of the present storage system 100 which includes s a PCM technology based advanced storage integrated local memory 112 that is used by system 100 also as a Direct Attached DS to serve the storage needs of other clients in the system 100. Client D. 114 is another client in system 100, yet this client 114 has no integrated SCM type fast access solid state memory, unlike that the other system 100 clients 102, 106 and 110 do have, yet due to the present invention it can benefit from using and implementing for fast access storage needs the flash memory DS, of DS 104 and 108 as well as the PCM solid state memory 112 for some applications where fast memory access needs are required. Shared storage 122 is used by the system 100 as the main storage resources data container and manager DS, serving the data management needs of the entire storage system 100. Shared storage 122 has its own Flash memory 118 that is used for its own local fast memory access needs as a Tier1 memory device. HDD memory 122 is used to serve the storage system 100 as its mass memory Tier2, for large storage capacity support needs.

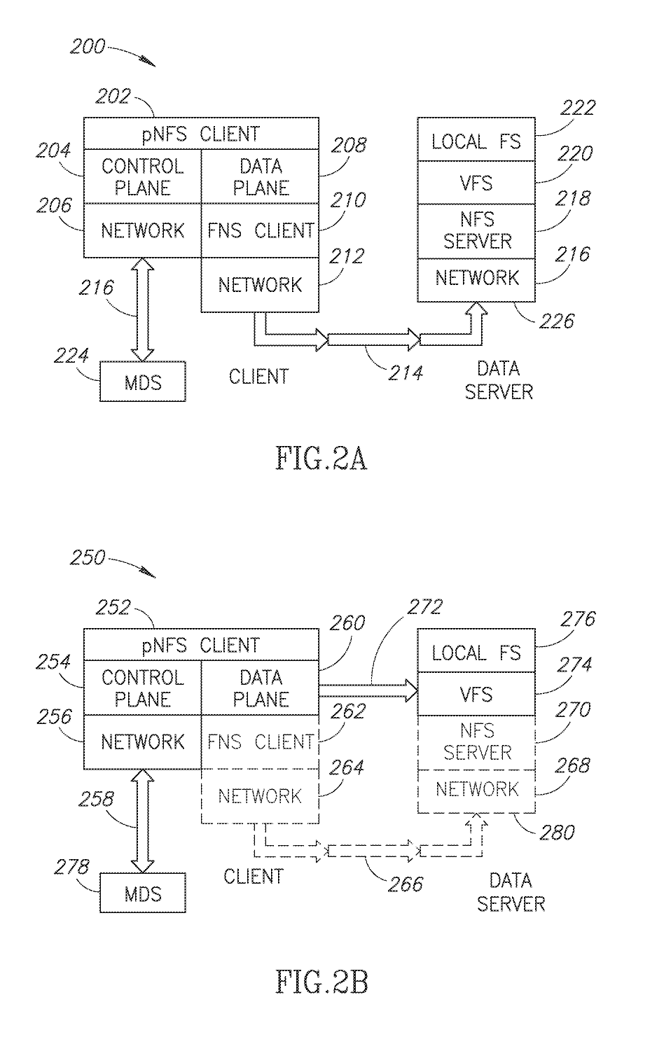

Reference is now made to FIGS. 2A, which is an example of the full transport path that a pNFS client 202 has to traverse even if the other DS 226 is on the same physical node. The pNFS client 202 is comprised of a control plane 204 and a data plane 208. The control plane 204, via a network stack 206 and a communication channel 226 approaches the Meta Data Server (MDS) 224 and retrieves the layout for a particular byte range that points at said data server 226. The data plane 208, in some pNFS layout driver types, such as the flex-files layout type, use a regular NFS client (e.g. NFS version 3) to access the data server 226, via the networking stack 212 and the virtual in this case communication channel 214. In a LINUX-based data server 226, such an 10 access would go up the networking stack 216, and via the NFS server 218, reach the generic virtual file system layer ((VFS) 220 and routed the local file system 222. This description suits a pNFS transfer protocol, such as in the case of a flex-file layout type. In this particular example, Data transfer symbolic arrow 214 demonstrates the transfer of the i/o data access from the client 202 to another data server 226 that resides in the same operating system.

In the optimization we propose, the pNFS data plane 208 (260 in FIG. 2B) would bypass most layers, if all operate on the same operating system and will approach the VFS 220 (274 in FIG. 2B) and through that to the local file system 222 (276 in FIG. 2B).

Reference is now made to FIGS. 2B, which is an example of the shortened transport path that a pNFS client 202 has to traverse in one of the present invention possible embodiments, wherein a pNFS client layout driver is modified to propose an optimized bypass for local traffic from a pNFS client to the client side Flash, or to any SCM local memory in general, while using it as a Direct Attached DS. The operation is managed and controlled by the Meta Data Server (MDS) 278 through the communication channel 258 that symbolizes the MDS 278 communication with the system relevant pNFS client 252 and the local Direct Attached DS 280 through the Network 256 and the system Control Plane 254. The pNFS layout driver under this invention embodiment method, can approach in a shortened path, the 280 Direct Attached DS, while connecting the Client 252 directly through the client data channel 272 to the Direct Attached DS 280, VFS 274 level and through that level to the 280 Direct Attached Local File System 276 level. pNFS client 252 is controlling the transfer of data that resides on its Data Plane 260, from there the process is bypassing over the previously described pNFS layout drive case as of the FIG. 2A, omitting the prior art required file transfer stages 262,264,266,268 and 270 (drawn with dotted outlines to clarify their absence in this Tier0 DS I/O data management present invention embodiment method) and transferring data instead, typical to this case, directly to the VFS level 274 and then in the next level transferred to be stored on the final storage level of the Local File Server 276 of the Direct Attached DS 280.

We defined the Average Storage Access Time formula (ASAT) as a parameter of optimization of the storage system access time to stored files while choosing between Direct Access DS and Shared DS as the optimal storage solution for the various system clients data storage and access requirements.

ASAT=Local DS Access Time+Local DS Miss Rate*Local DS Miss Penalty.

According to some embodiments of the present invention related to Direct Attached DS creation and their storage selection for use in the storage system, the proposed methods and system configuration enables the system to bypass the NFS client and the server software stack for local Data Servers and thus reduce the parameter of the Local DS Access Time which it its turn reduces the ASAT score indicating the improvement of the storage system overall performance.
According to other embodiments of the present invention related to Direct Attached DS creation and their storage selection for use in the storage system, the relevant proposed methods and system configuration enable the placement of files on the data server they are speculated to be stored on, thus it reduces the ASAT formula Local DS Miss Rate parameter, which also in turn reduces the value of the storage system ASAT overall performance representing parameter and score.

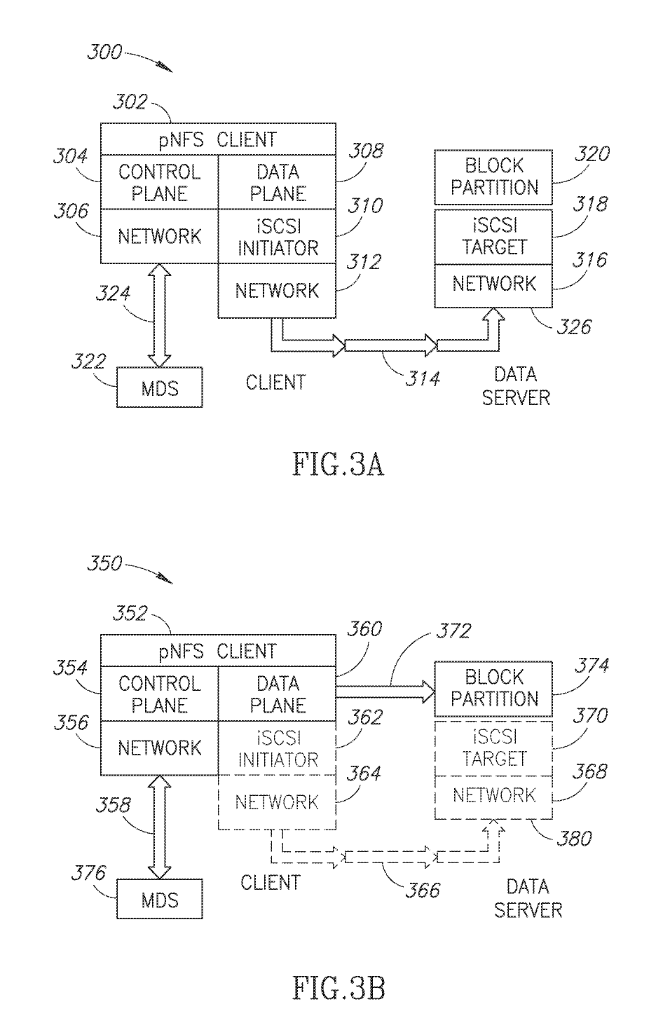

Reference is now made to FIGS. 3A, which is an example of the full transport path that a pNFS client 302 has to traverse even if the other DS 320 is on the same node. This example is representing other pNFS layout types, specifically the Block layout cases. In the Block layout the transport protocol is Block (SCSI), which has many variants, in which iSCSI would be the most interesting example. In Block terminology the client is called iSCSI Initiator and the server is called iSCSI Target. The bypass path would be pNFS layout driver or SCSI layer.

The operation is managed and controlled by the Meta Data Server (MDS) 322 through the data transfer arrow 324 that symbolizes the MDS 322 data communication with the system relevant clients 302 and 326 through the Network 306 and the system Control Plane 304. The pNFS layout driver (SCSI Layer) can approach the iSCSI Target 318 and through that to the DS local Block Partition 320. This suites a pNFS Block related transfer protocol. pNFS client 302 is controlling the transfer of data that resides on data plane 308, from there is being transferred to the iSCSI Initiator 310 and then to the system network 312. Data transfer symbolic arrow 314 demonstrates the transfer of the I/O data access from the client 302 to another data server 326 that resides in the same operating system. Data Server 326 at the other system side has its own pNFS network layer 316, then the relevant data is transferred to the second same node resident DS ISCSI Target 318 level and then it is transferred and stored in Block Partition layer 320.

Reference is now made to FIGS. 3B, which is an example of the shortened transport path that a pNFS client 352 has to traverse in one of the present invention possible embodiments, wherein a pNFS client layout driver is modified to propose an optimized bypass for local traffic from a pNFS client to the client side Flash, or to any SCM local memory in general, while using it as a Direct Attached DS. This example is representing other pNFS layout types, specifically the Block layout cases. The operation is managed and controlled by the Meta Data Server (MDS) 376 through the communication arrow 352 that symbolizes the MDS 376 data communication with the system relevant pNFS Network 356 interface and the local Direct Attached DS 380 through the Network 356 and the system Control Plane 354. The pNFS layout driver under this invention embodiment method, can approach in a shortened path, the 380 Direct Attached DS, while connecting the Client 352 directly through the client Data Plane 360 to the Direct Attached DS 380, to the Data server Block partition level side at the Attached Storage 380 side. pNFS client 352 is controlling the transfer of data that resides on its Data Plane 360, from there the process is bypassing over the previously described pNFS layout drive case as of the FIG. 3A file, regarding omitting the prior art required transfer stages 362,364,366,368 and 370 (drawn with dotted outlines to clarify their absence in this Tier0 DS I/O data management embodiment method) and transferring data instead, typical to this case, directly to the Block Partition level 374.

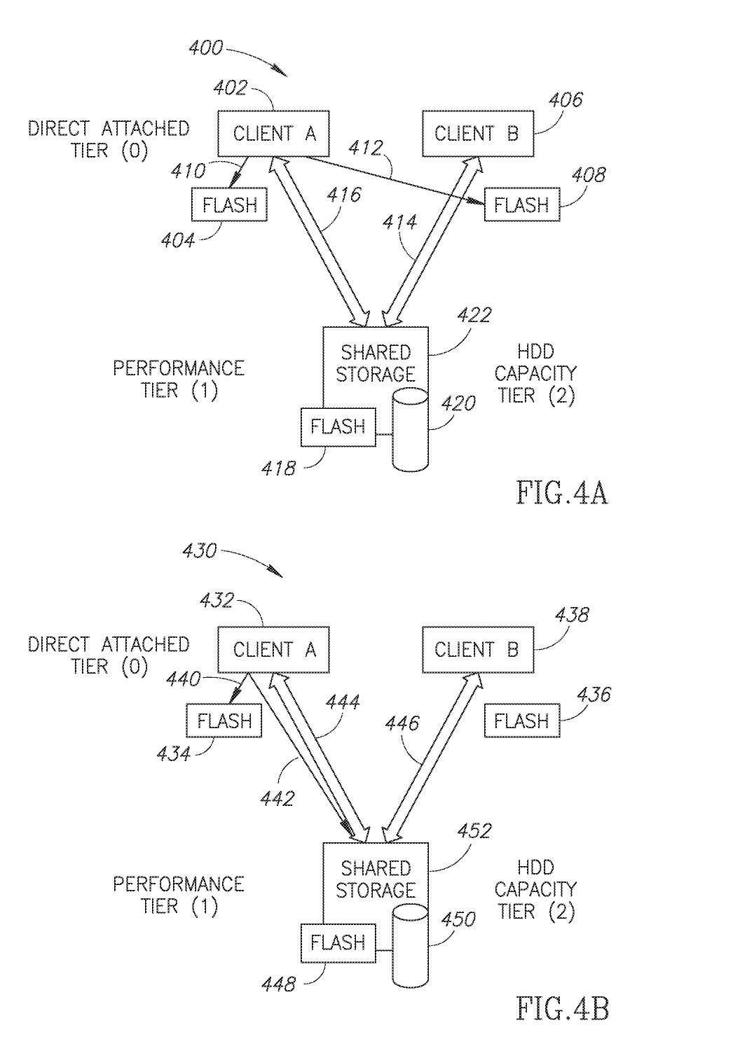

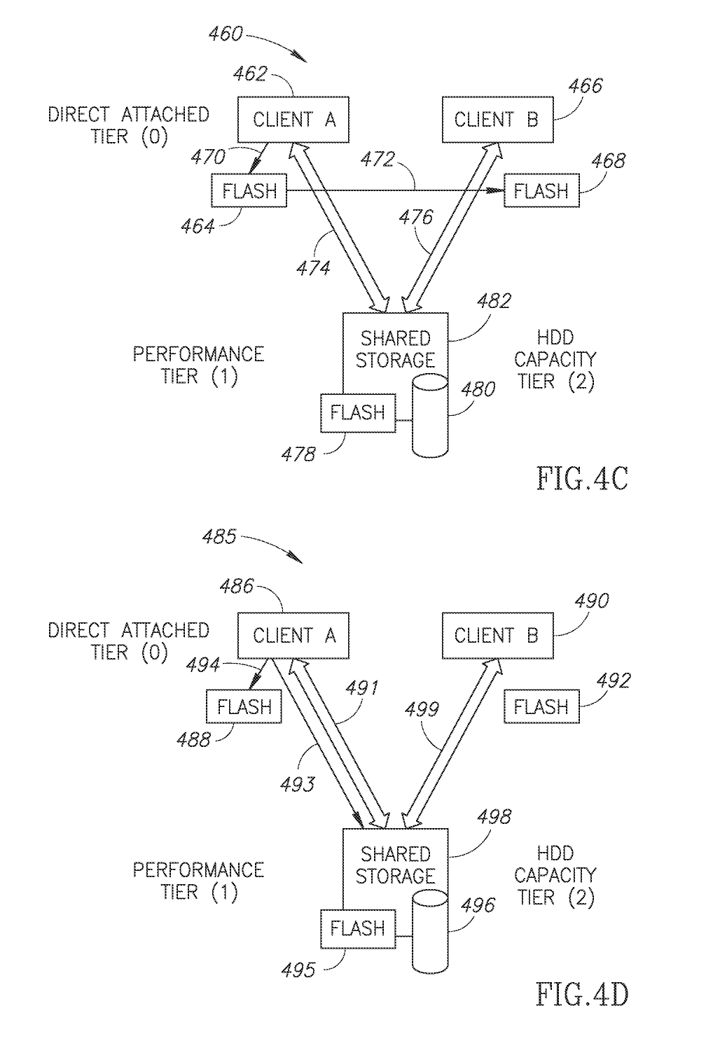

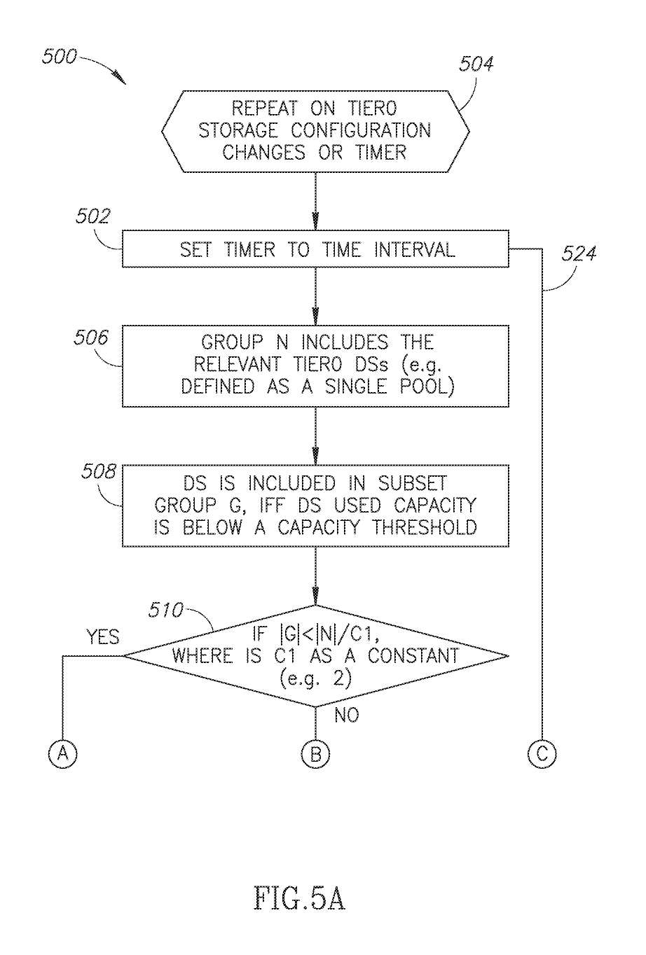

Reference is now made to FIG. 4A, which is a schematic illustration of one embodiment of the present invention computerized storage system with MDS managed storage content and configuration 400 under pNFS, while implementing mirroring of files according to some embodiments of the present invention and wherein client A 402 is mirroring and storing at the end of the mirroring process, one or more files stored in its Direct Attached DS 404 copied and stored also in client B 406 direct attached DS 408. Client A 402 is first managed by the storage system MDS (not shown here) to convert its integrated Flash memory device 404 into a Direct Attached memory DS, that can be then shared as a regular DS with other clients in the storage system 400. Then when mirroring activities of the selected relevant files or Blocks data content is initiated by the system 400 MDS, then the relevant data that resides in Client A 402 is mirrored directly from Client A 402 to the Flash memory 408 of Client B. The data transfer link 412 demonstrates the relevant files or Blocks copied and mirrored data transfer route, when mirrored from Client A. 402, wherein the data in this mirroring method embodiment is copied and transferred directly from client A 402 to the direct Attached Flash based DS 408 that resides at Client B 406. The data transfer links 416,414 demonstrate the relevant files or Blocks data usage related and their transfer routes from Client A 402 to the Shared Storage 422 and from Client B 406 to the Shared Storage 422. The system 400 Shared Storage 422 includes in its shared storage layers also a Tier 1 solid state data server 418 that may be selected by any advanced memory unit selected from the group defined as Storage Class Memory (SCM) to ensure fast data access and reliable long term operation. In parallel the shared storage 422 may include another mass memory HDD type module 420 that can serve the system 400 as a large capacity mass storage.

Reference is now made to FIG. 4B, which is a schematic illustration of another possible embodiment of the present invention computerized storage system 430 with MDS managed storage content and configuration operated under pNFS, while implementing mirroring of files according to some embodiments of the present invention method and wherein client A 432 is mirroring and storing at the end of the mirroring process, one or more files stored in its Direct Attached DS 434 copied and stored also in its Shared Storage unit 452. Client A 432, if required, is first managed by the storage system MDS (not shown here) to convert its integrated Flash memory device 434 into a Direct Attached memory DS, that can be then shared as a regular DS with other clients in the storage system 400, according to other embodiments of the present invention method and system configuration. When mirroring activities of the selected relevant files or Blocks data content is initiated by the system 430 MDS, the relevant data that resides in Client A 432 Direct Attached memory 434 is mirrored directly from Client A 432 to the Shared Storage memory 452. The data transfer links 444,446 demonstrate the relevant files or Blocks data usage related and their transfer routes from Client A 432 to the Shared Storage 452 and from Client B 436 to the Shared Storage 452. The data transfer links 440,442 demonstrate the relevant files or Blocks copied and mirrored data transfer route, when mirrored from Client A. 432, wherein the data in this mirroring method embodiment is copied and transferred directly from client A 402 to the direct Attached Flash based DS 434, that resides at Client A 432 and in parallel also to the Shared Storage 452 unit. The system 430 Shared Storage unit 452 includes in its shared storage layers also a Tier1 solid state data server 448 that may be an advanced technology memory unit selected from the group defined as Storage Class Memory (SCM) to ensure fast data access and reliable long term operation. In parallel the shared storage 452 may include another Tier2 mass memory HDD type module 450 that can serve the system 430 as a large capacity mass storage solution.

Reference is now made to FIG. 4C, which is a schematic illustration of another possible embodiment of the present invention computerized storage system 460 with its MDS managed storage content and configuration, operating under pNFS, while implementing mirroring of files according to some embodiments of the present invention and wherein client A 462 is mirroring and storing at the end of the mirroring process, one or more files stored in its Direct Attached DS 464 copied and stored also in client B 466 direct attached DS 468. Client A 402, and Client B 466, if required are first managed by the storage system MDS (not shown here) to convert their integrated Flash memory devices 464 and 468 into Direct Attached memory DSs, that can be then shared as a regular DS with other clients in the storage system 460 according to one embodiment of the present invention. When mirroring activities of the selected relevant files or Blocks of data content is initiated by the system 460 MDS, then the relevant data that resides in Client A 462 Direct Attached DS 464 is mirrored directly from Direct attached DS 464 to the Flash based Direct Attached memory 468 of Client B 466. The data transfer link 472 demonstrates the relevant files or Blocks mirrored data transfer route, when mirrored from Client A. 462 as the data origin, wherein the data in this mirroring method embodiment is first copied and transferred directly from client A 462 to its Direct Attached DS 464 and then mirrored from Direct Attached DS 464 directly to the Direct Attached 468 DS memory. The data transfer links 474,476 demonstrate the relevant files or Blocks data usage related and their transfer routes from Client A 462 to the Shared Storage 482 and from Client B 466 to the Shared Storage 482. The system 460 shared storage 482, includes in its shared storage layers also a Tier1 solid state data server 478 that may be selected by any advanced memory unit selected from the group defined as Storage Class Memory (SCM) to ensure fast data access and reliable long term operation. In parallel the shared storage 482 may include another mass memory HDD type module 480 that can serve the system 460 as a large capacity mass storage solution.

Reference is now made to FIG. 4D, which is a schematic illustration of another possible embodiment of the present invention computerized storage system 485 with MDS managed storage content and configuration operated under pNFS, while implementing mirroring of files according to some embodiments of the present invention method and wherein client A 486 is mirroring and storing at the end of the mirroring process, one or more files stored in its Direct Attached DS 488 copied and stored also in its Shared Storage unit 498. Client A 486, if required, is first managed by the storage system MDS (not shown here) to convert its integrated Flash memory device 488 into a Direct Attached memory DS, that can be then shared as a regular DS with other clients in the storage system 485, thus according to other embodiments of the present invention method and system configuration. When mirroring activities of the selected relevant files or Blocks data content is initiated by the system 485 MDS, the relevant data that resides in Client A 486 Direct Attached memory 488 is copied directly from Client A 486 to the Shared Storage memory 498. The data transfer links 494,493 demonstrate the relevant files or Blocks data usage related and their transfer routes from Client A 486 to the Direct Attached DS 488 and then mirrored from the Direct Attached DS 488, directly to the Shared Storage 498. The data transfer links 491,499 demonstrate the relevant files or Blocks copied and mirrored data transfer routes, from Client A 486 to the Shared Storage 498 and from Client B 490 to the Shared Storage 498. The system 485 Shared Storage unit 498 includes in its shared storage layers also a Tier1 solid state data server 495 that may be an advanced technology memory unit selected from the group defined as Storage Class Memory (SCM) to ensure fast data access and reliable long term operation. In parallel the shared storage 498 may include another Tier2 mass memory HDD type module 496 that can serve the system 485 as a large capacity mass storage solution.

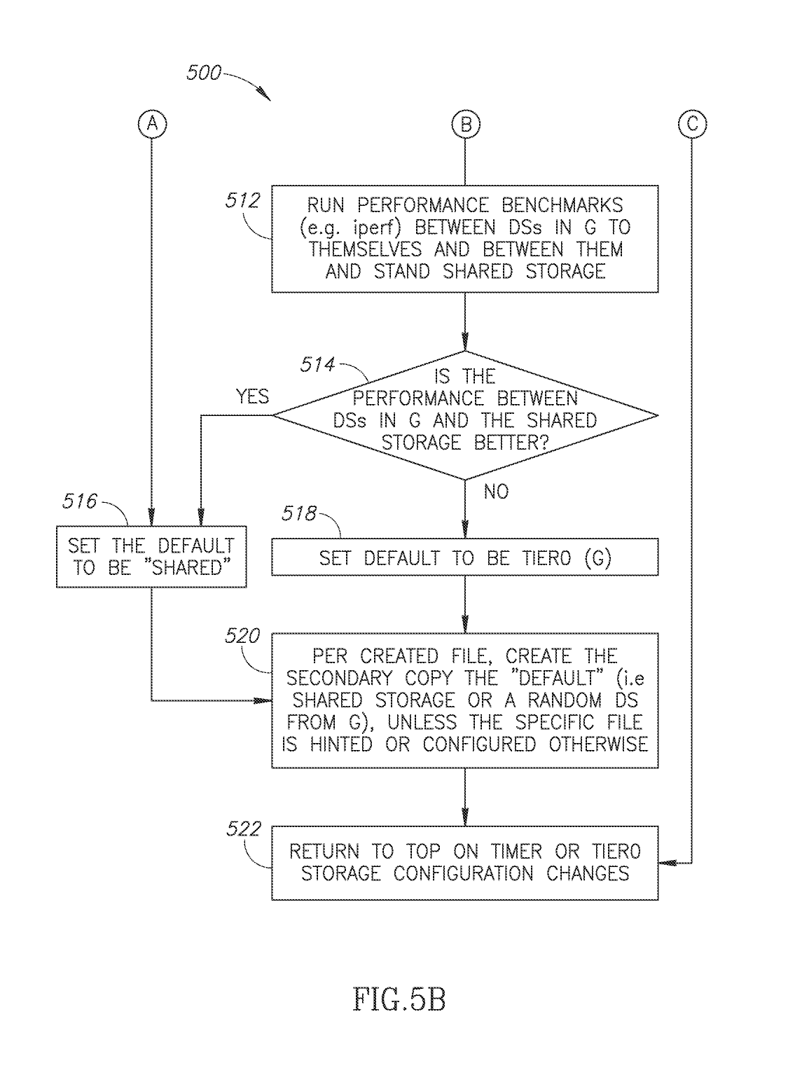

Reference is now made to FIG. 5, which is a schematic flow chart illustration of a state machine wherein states reflect actions and transition arrows relate to internal or external triggers, which are performed in the storage system MDS with regard to a certain files content concerning secondary mirrored file copies and their DS storage optimal target selection decision, while selecting a Direct Attached DS (Tier0) or a Tier1 DS as the target for storing a secondary mirrored copy by the system data server, executing a mirroring decision algorithm, that is implemented according to one embodiment of the present invention. The algorithm of the mirroring method starts by setting a timer at stage 502 for a time intervals when a decision on the selecting the optimal DS for mirroring target is to be made. 504 is a repeat cycle instruction to trigger stage 502 upon any evaluated Tier0 storage configuration changes or on new mirroring cycle timer changes. In stage 506 the system groups all N relevant Direct Attached (tier0) Data Servers (e.g. Tier0 DSs that are defined as a single pool of DSs). In stage 508 DS is selected to be included in a subset DS group “G”, only if the selected DS used capacity is below a pre defined capacity threshold. In decision stage 510 the system manager evaluates if the size of the sub group G is lower than the total number of relevant Tier0 DSs divided by a factor C1, wherein C1=2 in most cases. If the size of group G is not smaller than of the size of group N divided by C1 then the selection of the target DS for mirroring is continued, alternatively if the size of G is bigger than N/C1 then the algorithm state machine moves to stage 520 where per created file the system creates a second default copy on a Shared Storage, or on a random DS selected from the G group of DSs. On the other hand if the DS number sizes of the two groups evaluation question in stage 510 shows that group G is bigger than group N/C1, than the state machine is moving to stage 512, the System manager is then running a performance benchmarks between the DSs in group G and between them and the Shared Storage. In the following stage 514 which is an evaluation and decision stage, when the system manger is evaluating if the measured performance of the group of Tier0 DSs in group G is not better than of the performance evaluated of the Shared Storage, if the performance of the evaluated Shared Storage is not better than of the evaluated performance of the evaluated Tier0 DS, then the state machine is moving to stage 518 where the system is setting the default mirroring target DS to the Tier0 DS selected from group G. Then in the following stage 520 per each newly created file the system creates and stores the file secondary copy on the default Tier0 DS selected from group G Tier0 Data Servers. On the other hand if the measured performance in stage 512 of the Shared Storage is better than that of the DS from the Tier0 DS group, then the system is setting the default target DS for new files mirroring to be stored in the Shared Storage DS. Then in Stage 520 in such a case the shared copy of the new file if stored in the Shared Storage acting as the default target DS for filing newly created files.

In the process final stage 522 the system returns to stage 502 to re-start again the mirroring of new files and selecting for them the target DS for its storage process, either based on the following planned time point, that is set up by the system timer, or when there are Tier0 storage configuration changes.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A computerized method for configuration and management of storage resources to scale-out a NAS that can effectively utilize a client Direct Attached fast access, advanced solid state Storage Class Memory modules, such as Flashes, in a storage configuration and management method that is based on pNFS, wherein;
a. said pNFS is comprised of a meta-data server (MDS) and data servers (DSs) and a client;
b. said NAS contains at least two DSs and at least one of them is a Direct Attached DS that co-resides with said client; and
c. wherein said configuration is based on said client-side SCM being further exported as a data server.

2. The computerized method of claim 1, wherein;
a. said pNFS client is modified to support the creation of an optimized bypass for local traffic;
b. IO access from a client to the Direct Attached DS that resides on the same operating system, is configured to use a local file system or a local block partition instead of a network based transport protocol; and
c. said pNFS client uses network to access other data servers.

3. The computerized method of claim 2, wherein;
a. IO access from a client to the Direct Attached DS that resides on the same operating system, is configured to use the local file system for the flex-files layout as the transport protocol; and
b. said pNFS client layout driver uses a NFS client to access other data servers.

4. The computerized method of claim 2, wherein;
a. IO access from a client to the Direct Attached DS that resides on the same operating system, is configured to use a local block partition for the block layout as the transport protocol; and
b. said pNFS client layout driver uses a SCSI initiator to access other data servers.

5. The computerized method of claim 1, wherein;
said MDS placement policy for new files so as to save network traversals is modified to prefer said Direct Attached data server on the creating client, subject it has a sufficient storage capacity for it.

6. The computerized method of claim 1, wherein;
a. an in-band Direct Attached Data server counts or assesses the access per file;
b. if said Direct Attached Data server decides that node X client is the significant user of a file in the last time period, it could decide to migrate the file to another Direct Attached data server that is located on said node X; and
c. said file migration is dependent on node X existence and availability of spare capacity.

7. The computerized method of claim 1, wherein;
a. an out-of-band MDS counts or assesses the access per file;
b. if said MDS decides that node X client is a significant user of a file in the last time period, it could decide to migrate the file to a Direct Attached data server that is located on said node X; and
c. said file migration is dependent on node X existence and availability of spare capacity.

8. The computerized method of claim 1, wherein said MDS can leverage information from a higher level framework, such as from a vCenter plug-in, to speculate and migrate a file to a node closer to the application using it.

9. The computerized method of claim 1, wherein shared storage improved data access to a Direct Attached data server located on node X is achieved by files mirroring to provide at least one of the group of benefits, comprising:
a. providing a level of inter-node redundancy; and
b. accelerating client reads by sharing the load, so that not all clients have to address said node X.

10. The computerized method of claim 9, wherein access is faster from/to a Direct Attached data server, providing that that is an option for a particular file while the secondary copy of said file could be kept in another data server selected from the group comprising of; a Direct Attached data server, and a shared storage DS.

11. The computerized method of claim 9, wherein said Direct Attached data server maybe a randomly selected best for rebuild Direct Attached DS or a defined particular secondary Direct Attached DS for a specific file, which is best if a higher level framework or application has a designated secondary node in mind, for failover scenarios.

12. The computerized method of claim 9, wherein the default usage of Direct Attached DS and Tier1 DS for secondary copies is performed automatically by an algorithm that evaluates the network topology, DS capacities and performance utilization levels in order to decide on the optimal DS tier selected choice per time interval.

13. The computerized method of claim 12, wherein said algorithm is;
a. the usage of a Direct Attached DS is discouraged if the network topology does not provide good client to client communication;
b. not to allocate secondary on DSs with little free space (capacity);
c. if this applies to all the available Direct Attached DSs then choose a Tier1 DS, which is usually less sensitive to said limited capacity being easier to administer.

14. The computerized method of claim 12, wherein said algorithm is;
a. the usage of a Direct Attached DS is discouraged if the network topology does not provide good client to client communication;
b. not to allocate secondary on an over utilized DS, which cannot support the required performance;
c. if this applies to all the available shared storage DSs then choose a Direct Attached DS storage, as the Shared Storage is more likely to become the bottleneck.

15. A computerized system with a storage configuration and management of enhanced storage resources, so as to scale-out a NAS that can effectively utilize client Direct Attached fast access, Storage Class Memory modules, such as Flashes, operating under a storage configuration and management method based on pNFS, wherein;
a. said pNFS is comprised of a meta-data server (MDS) and data servers (DSs) and at least one client;
b. said NAS contains at least two DSs and at least one of them is a Direct Attached DS that co-resides with one of said at least one clients; and
c. wherein said configuration is based on said client-side SCM being further exported as a data server.

16. The computerized system of claim 15, wherein;
a. said pNFS client is modified to support the creation of an optimized bypass for local traffic;
b. IO access from a client to the Direct Attached DS that resides on the same operating system, is configured to use a local file system or a local block partition instead of a network based transport protocol; and
c. said pNFS client uses network to access other data servers.

17. The computerized system of claim 16, wherein;
a. IO access from a client to the Direct Attached DS that resides on the same operating system, is configured to use the local file system for the flex-files layout as the transport protocol; and
b. said pNFS client layout driver uses a NFS client to access other data servers.

18. The computerized method of claim 16, wherein;
a. IO access from a client to the Direct Attached DS that resides on the same operating system, is configured to use a local block partition for the block layout as the transport protocol; and
b. said pNFS client layout driver uses a SCSI initiator to access other data servers.

19. The computerized system of claim 15, wherein;
a. an in-band Direct Attached Data server counts or assesses the access per file;
b. if said Direct Attached Data server decides that node X client is the significant user of a file in the last time period, it could decide to migrate the file to another Direct Attached data server that is located on said node X; and
c. said file migration is dependent on a node X existence and availability of spare capacity.

20. The computerized system of claim 15, wherein shared storage improved data access to a Direct Attached data server located on node X is achieved by files mirroring to provide at least one of the group of benefits, comprising:
a. providing a level of inter-node redundancy, and b. accelerating client reads by sharing the load, so that not all clients have to address said node X.
